(19) United States
(12) Patent Application Publication
(10) Pub. No.: US 2020/0216778 A1
(43) Pub. Date: Jul. 9, 2020

(54) COMPOSITION AND USE THEREOF FOR FINISHING FIBRES AND TEXTILES

(71) Applicant: RUDOLF GMBH, Geretsried (DE)

(72) Inventors: Johann HEIMGREITER, Bairawies (DE); Rainer Wilhelm BRAUN, Bad Heilbrunn (DE); Gunther DUSCHEK, Benediktbeuern (DE)

(73) Assignee: RUDOLF GMBH, Geretsried (DE)

(21) Appl. No.: 16/613,983

(22) PCT Filed: Jun. 13, 2018
(86) PCT No.: PCT/EP2018/065631

§ 371 Date: Nov. 15, 2019

(30) Foreign Application Priority Data
Jun. 14, 2017 (EP) 17175966.5
Apr. 9, 2018 (EP) 18166361.8

(51) Int. Cl. C11D 1/83; C11D 3/43; C11D 3/37; D06M 15/356; D06M 13/17; D06M 13/256; D06M 13/292; D06M 15/61

(52) U.S. Cl. CPC C11D 1/83; C11D 3/43; C11D 3/3773; D06M 15/61; D06M 13/17; D06M 13/256; D06M 13/292; D06M 15/3562

(57) ABSTRACT

The present invention relates to compositions comprising at least one cationic polyelectrolyte, at least one anionic compound and at least one non-ionic surfactant and to the use thereof for finishing fibres and textiles.

The present invention relates to compositions comprising at least one cationic polyelectrolyte, at least one anionic compound and at least one non-ionic surfactant and to the use thereof for finishing fibres and textiles.

Higher and higher requirements are being placed on textiles nowadays. Depending on the field of application, textiles are to be for example hydrophobic, hydrophilic, flame-retardant, antistatic, wrinkle-proof, oil-repellent, weather-resistant etc. For a long time, it has no longer been possible to meet these requirements simply through the selection of a suitable fibre material, Therefore, in the technical field, the surface of the fibres and/or textiles is increasingly being chemically modified, in other words finished, so as to tailor the profile of the properties of the textile depending on the field of application.

Textiles are usually made of fibres, a distinction being made between natural fibres, in other words fibres obtained without chemical alteration from plant fibres such as cotton or animal fibres such as wool or silk, and synthetic fibres. By contrast with natural fibres, most synthetic fibres have major advantages:
lower tendency to wrinkle
higher tear and abrasion resistance
high variability of properties from the selection of the monomers
low weight
low production costs

Therefore, at present more synthetic fibres than natural fibres are processed into textiles worldwide. In spite of the advantages, synthetic fibres also have drawbacks, however. Thus, synthetic fibres become more highly electrostatically charged than natural fibres. Synthetic fibres also barely absorb moisture, and this has a negative effect on the wearing comfort. In some fields, textiles made of synthetic fibres can therefore not be used at all or only be used to a limited extent, for example through combination with natural fibres.

To give synthetic fibres antistatic and/or hydrophilisation properties, finishing agents may be used, which are applied to the surface of the fibres or textiles. However, it is generally difficult to fix the finishing agents to synthetic fibres in a wash-resistant manner, since synthetic fibres have few or no functional groups which can bind the finishing agent permanently to the fibre or the textile, for example by way of covalent, ionic or van der Waals interactions. To solve the problem, in most cases finishing agents are used which are self-crosslinking or can be crosslinked by a further component. Whilst these finishing agents usually have a higher wash-resistance, the feel of textiles finished in this manner is unsatisfactory. In addition, the crosslinking reaction usually takes place at higher temperatures, for example at 150° C. These reaction conditions are not suitable for all fibres, and may lead to undesired yellowing, chemical decomposition reactions and changes in shape of the fibre and/or textile, Crosslinkable finishing agents are also criticised for health reasons, since the functional groups of the crosslinking agents, for example epoxy, chlorohydroxyl or (blocked) isocyanate groups are suspected to be hazardous to health or even toxic. Finally, the high energy expenditure for the finishing is of ecological concern.

Alternatively, finishes using complexes of cationic and anionic preparations are proposed so as to achieve corresponding wash-resistance on a fibre or a textile. For this purpose, a two-stage process is usually carried out in which cationic and anionic components are applied in succession.

EP 0 603 987 A1 describes a two-step method in which a layer of cations and anions is applied to a substrate in succession. The best wash-resistance is achieved at a stoichiometric ratio between anions and cations, but the hydrophilicity is insufficient under these circumstances. The hydrophilicity can be improved by varying the charge ratio between anions and cations, but this has an equally negative influence on the wash resistance. The described systems do not achieve acceptable hydrophilic properties along with simultaneously acceptable wash-resistance.

In WO 2006/015080 A1, substrates are alternately finished cationically and anionically. To avoid depositions in the individual baths, there is a washing step between the steps in each case. A drawback of this method is that the polymers do not build up in quantity, and so precipitates form in the liquor, which are deposited on the fibres or textiles and thus cause specks. The washing step thus additionally involves considerable additional expenditure and loss of product.

In U.S. Pat. No. 6,060,410 B, a solution consisting of a highly sub-stoichiometric ratio of cationic and anionic molecules is applied to a substrate. In a second bath, the ionic groups which are still free are displaced with an oppositely ionic hydrophobisation component.

Two-step processes for forming complexes are also proposed in U.S. Pat. No. 5,208,111 B and US 2004/0185284 A1.

The described two-step processes involve high production expenditure; at the same time, it is difficult to ensure process stability, since forming insoluble complexes in the liquor leads to the risk of undesired depositions on the fibre or textile.

Water-insoluble cation/anion complexes may also be used as solids. For this purpose, the complexes are generally precipitated in aqueous systems as ion pairs and subsequently separated out, dried and/or granulated. The products may be used in plastics material solid bodies or other non-aqueous formulations. These dry, water-insoluble complexes are not suitable for finishes in aqueous media, since they are not sufficiently finely distributed to prevent depositions and specks.

U.S. Pat. No. 6,596,678 B2 describes a pulverulent cleaning agent composition comprising a polyelectrolyte complex of cationic and anionic polymers. The polyelectrolyte complex is present in the washing liquor as a particle, which is deposited on the textiles to be cleaned and protects them during the washing processes. During subsequent rinsing, the complex is washed out again.

In WO 2011/131728 A1, an anion/cation complex precipitated in water is dried after filtration and used as an additive in plastics material solid bodies.

The above-described anion/cation complexes are all not suitable for finishing textiles, since homogeneous application to the fibres or textile is not possible or may even cause specks on the textile.

U.S. Pat. No. 3,622,378 B describes mixtures of anionic and cationic surfactants and an amphoteric surfactant. The complexes are precipitated as soon as the mixture is diluted. The treated fibres and textiles furthermore do not have the desired wash-resistance.

DE 19 852 584 A1 and U.S. Pat. No. 6,060,410 B describe aqueous dispersions of cation/anion complexes. The dispersions are homogenised mechanically, for example using ultrasound. However, the liquor is only metastable and has a strong tendency towards agglomeration. Thus, the liquor is only suitable to a limited extent for use as a finishing agent, partly because there is the risk that depositions and speck formations occur on the textile to be finished.

EP 0 603 987 B1 relates to a permanent hydrophilic/cationic surface coating. The surface to be coated is dipped in an aqueous solution of a cationic surfactant and/or polymer. To form the ion complex, an anionic surfactant and/or polymer is applied to the surface. Alternatively, a dispersion of the anion/cation complex is proposed for coating filters. The described ion complex is not suitable for coating fibres or textiles, since sufficiently stable liquors cannot be produced.

In conclusion, the prior art finishing agents have the following drawbacks:
complex multi-step processes during application
increasingly rigid feel
thermal yellowing
use of physiologically unfriendly starting products
lack of wash-resistance
risk of speck formation as a result of uncontrolled depositions

It also has not been possible thus far to provide an aqueous product by means of which a textile or a fibre can permanently be given antistatic and hydrophilic properties. The object of the invention is therefore to overcome the drawbacks of the prior art.

Surprisingly, it was possible to achieve the object by providing a composition comprising
(A) at least one cationic polyelectrolyte,
(B) at least one anionic compound,
(C) at least one non-ionic surfactant, and
(D) optionally at least one liquid medium.

The composition may be in the liquid or solid state, the composition preferably being present as a colloid, granulate or powder. In a preferred embodiment, the composition is in the form of a colloid. In this case, the colloid particles preferably have an average diameter of 5 nm to 3 μm, more preferably of 10 nm to 2 μm, even more preferably of 40 nm to 1.5 μm and even more preferably of 40 nm to 500 nm. Preferably, the composition is optically transparent or opaque.

Polyelectrolytes are polymers having side-chain or main-chain ionic groups. Thus, the cationic polyelectrolyte (A) is a polymer having side-chain and/or main-chain cationic groups, in particular having side-chain cationic groups. Preferably, the cationic group is permanently cationic in the polyelectrolyte, in other words regardless of the reaction conditions, for example regardless of the pH.

The cationic group in the polyelectrolyte (A) is preferably an ammonium, pyridinium, imidazolium, pyrrolidonium group or an N-substituted heteroaromatic group, particularly preferably a quaternary ammonium group.

The polyelectrolyte (A) is preferably obtainable by (i) polymerising at least three monomer units which each have a permanent cationic charge and/or (ii) by condensation reactions which lead to at least three cationic groups and/or (iii) by alkylation of at least three amino functions in a polymer into permanent cationic groups.

The polyelectrolyte (A) may be a homopolymer or copolymer. If the polyelectrolyte is a copolymer, the copolymer may comprise at least one repeating unit based on a comonomer selected from the group consisting of styrene, acrylonitrile, (meth)acrylic acid ester, (meth)acrylamide, (meth)acrylic acid, vinyl acetate and allyl alcohol derivative. If the comonomers include a chemically ionisable group, this may be converted to a permanent cationic group after polymerisation. Chemically ionisable groups are preferred, for example amino groups, which for example can be converted to quaternary ammonium ions by alkylation.

The permanently cationic charge in the monomer unit (i) is preferably an ammonium, pyridinium, imidazolium, pyrrolidonium group or an N-substituted heteroaromatic group, particularly preferably a quaternary ammonium group.

Preferred monomer units (i) are α,β-unsaturated hydrocarbon compounds which have a permanently cationic charge. Particularly preferred monomer units (i) are selected from the group consisting of diallyl dialkyl ammonium salt, in particular diallyl dimethyl ammonium chloride (DADMAC), trialkyl ammonium alkyl (meth)acrylate salt and trialkyl ammonium alkyl (meth)acrylamide salt.

The structures of particularly preferred monomer units (i) are shown in the following;

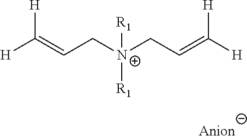

where
R₁=—C₁₋₄ alkyl, preferably —CH₃,
or

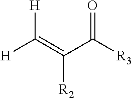

where
R₂=—H or —C₁₋₄ alkyl, preferably —CH₃, and

### R₃=

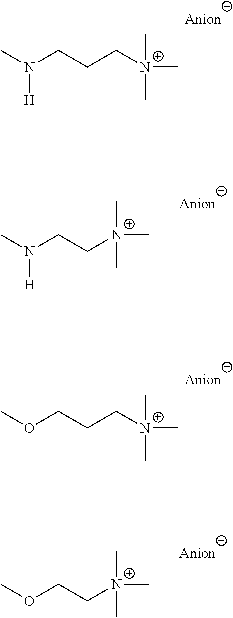

Alternatively, the cationic polyelectrolyte (A) may be produced by condensation reactions which lead to at least three cationic groups. A condensation reaction (ii) of this type preferably comprises conversion of at least one dialkyl amine, tertiary alkyl and/or (hetero)aryl diamine with at least one epihalohydrin and/or bishalide. In this case, the epihalohydrin is preferably epichlorohydrin or epibromohydrin, more preferably epichlorohydrin. The bishalide is preferably an α,ω-bishalide, preferably α,ω-bisalkylhalide or α,ω-bishalide alkyl ether. Preferred aminofunctional compounds for the condensation reaction (ii) with epihalohydrin and/or bishalide include:

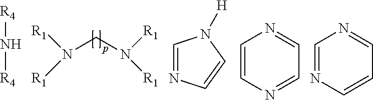

where
R₁ is as defined above
R₄=—CH₃, —C₂H₅, —C₃H₇, —C₄H₉,
p=2-6.

In a further alternative, the polyelectrolyte (A) may be obtained by polymerising at least three monomer units which each have at least one chemically and/or physically ionisable group. Preferably, the chemically ionisable group is an amino group which can be converted to a quaternary ammonium ion by alkylation. Therefore, in alternative (iii), the polyelectrolyte (A) is preferably obtained by alkylation of at least three amino functions in a polymer into permanent cationic groups.

Polymers having at least three amino functions selected from the group consisting of linear or branched polyalkylene imine, in particular polyethylene imine, are preferred. Alternatively, polymers having at least three amino functions may be obtained by polymerising at least three monomer units which each have at least one amino function, in particular diallyl dialkyl amine, vinyl amine, vinyl pyrazole, vinyl imidazole and/or aziridine. Preferred polymers having at least three amino functions are:

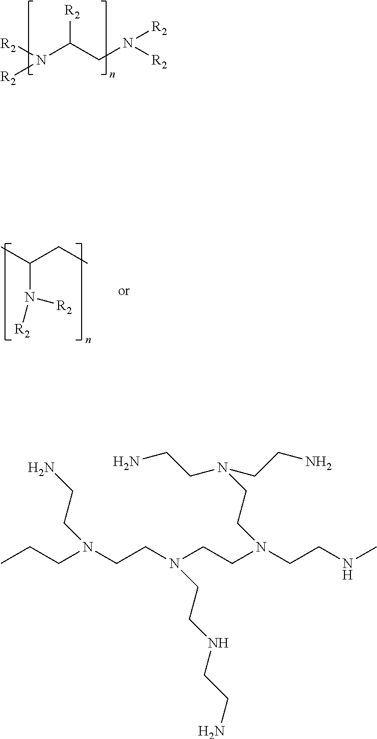

where
R₂ independently of one another are defined as above and
n is 3-100,000

The conditions and alkylation reagents for the alkylation of the amino functions in the polymer are sufficiently well known to a person skilled in the art. Preferred alkylation reagents are for example dimethyl sulphate, diethyl sulphate; methyl halogen, benzyl halogen, methyl tosylate, or 3-chloro-2-hydroxypropyl-N,N,N-trimethyl ammonium chloride (CHPTAC).

The polyelectrolyte (A) preferably has a number-average molecular weight of 1,000-5,000,000 g/mol, more preferably of 1,000-1,000,000 g/mol, even more preferably of 1; 500-1,000,000 g/mol and even more preferably of 2,000-500,000 g/mol,

The polyelectrolyte (A) is preferably structured in such a way that 30-100 mol %, preferably 50-100 mol %, of the repeating units have a cationic group.

In a preferred embodiment, the cationic charge density of the cationic polyelectrolytes (A) is 2.0-14.0 mEq/g, more preferably 2.3-13 mEq/g and most preferably 2.5-12 mEq/g.

The composition contains preferably 4-62% by weight; more preferably 5-55% by weight, of polyelectrolyte (A), based on the total mass of components A, B and C.

The anionic compound (B) preferably has at least one, more preferably 1-3, in other words 1, 2 or 3, anionic groups. In another preferred embodiment, the anionic compound (B) is an anionic polyelectrolyte.

Preferably, the anionic compound (B) comprises at least one phosphate, phosphonate, sulphate, sulphonate, carboxylate, sulphoacetate, sulphosuccinate and/or taurate group.

In a more highly preferred embodiment, the anionic compound (B) is selected from mono-, di-(C₄₋₂₂ alkyl(alkoxy)) phosphate, mono-, di-(C₄₋₂₂ alkyl) phosphonate, C₄₋₂₂ alkyl aminophosphonate, C₄₋₂₂ alkyl(alkoxy) sulphate, secondary alkyl sulphonate, petroleum sulphonate, C₄₋₂₂ alkyl sulfonate, C₄₋₂₂ alkyl aryl sulphonate, fatty alcohol ether carboxylate, fatty acid salt, fatty alkyl sulphoacetate, fatty acid amide ether sulphate, fatty alcohol ether carboxylate, nonyl phenol ether sulphate; fatty alkyl ether sulphate, C₄₋₂₂ alkyl polyalkoxylene phosphate and C₄₋₂₂ alkyl polyalkoxylene sulphate.

Preferred mono- or dialkyl(alkoxy) phosphates or -hydrogen phosphates are derived from the following acids:

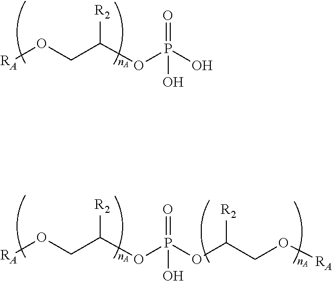

where
R₂ independently of one another are defined as above,
R_{A} independently of one another are a saturated or unsaturated hydrocarbon radical with 4-18 carbon atoms,
n_{A} independently of one another are 0-20.

A preferred alkyl alkoxy sulphate is derived from the following acid

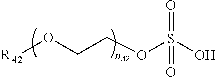

where
R_{A2} is a saturated or unsaturated hydrocarbon radical with 8-18 carbon atoms, and
n_{A2} independently of one another are 0-10.

A preferred alkyl aryl sulphonate is derived from the following acid

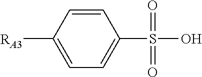

where
R_{A3} is a saturated or unsaturated hydrocarbon radical with 8-20 carbon atoms.

Alternatively, the compound (B) may be an anionic polyelectrolyte. The polyelectrolyte (B) is preferably a polymer having side-chain anionic groups. Polyelectrolytes of this type are preferably obtainable by polymerising at least three monomer units (iv), which each have at least one chemically ionisable group.

The ionisable group in the monomer unit (iv) is preferably a group which has an acidic proton, for example an acid group having ionogenically bonded hydrogen. Acid groups of this type can be deprotonated in an acid/base reaction by adding a base. Preferred examples of the monomer unit (iv) are (meth)acrylic acid, maleic acid, 2-acrylamide-2-methyl propane sulphonic acid (AMPS), allyl sulphonic acid and styrene sulphonic acid.

In a preferred embodiment, the polyelectrolyte (B) is a homopolymer or copolymer. The polyelectrolyte copolymer may comprise at least one repeating unit which is based on a comonomer, for example selected from the group consisting of styrene, acrylonitrile, (meth)acrylic acid ester and (meth)acrylamide.

The anionic polyelectrolyte (B) is preferably structured in such a way that 30-100 mol %, preferably 50-100 mol %, of the repeating units have an anionic group.

The anionic compound (8) makes up preferably 15-85% by weight, more preferably 20-80% by weight, based on the total mass of components (A), (B) and (C).

Component (A) and component (B) together form an ionic complex. This ionic complex forms a core to which the non-ionic surfactant (C) is bonded by way of hydrophobic interactions.

In a preferred embodiment, the ratio of the net charge in component (A) to the net charge in component (B) is 1:10 to 10:1, more preferably 1:7 to 7:1. The net charge of component (A) corresponds to the sum of all positive charges minus the sum of any negative charges present. The net charge of component (B) corresponds to the sum of all negative charges minus the sum of any positive charges present.

Component (C) is preferably an alkoxylation product of fatty acid, fatty acid ester, fatty acid amine, fatty acid amide, fatty alcohol, aliphatic mono-, di- or tri-alcohol, mono-, di- or tri-glyceride, alkyl phenol, sorbitan fatty acid and sugar derivatives or is trialkyl phenol polyalkoxylene or a block copolymer, for example poly(ethylene oxide-co-propylene oxide).

In a more highly preferred embodiment, the non-ionic surfactant (C) is selected from the group consisting of alkoxylated C₉-C₂₅ fatty alcohols, alkoxylated C₉₋₂₅ fatty acid amines, alkoxylated C₉-C₂₅ fatty acid amides, C₈-C₂₅ fatty acids alkoxylated at the carboxylate function, alkoxylated C₈-C₂₅ fatty acid esters, alkoxylated C₈-C₂₅ alkyl phenols and alkoxylated mono-, di- or triglycerides of C₅-C₂₅ fatty acids and/or the esterification products thereof with C₈-C₂₅ fatty acids or trialkyl phenyl polyalkoxyls or a block polymer, for example poly(ethylene oxide-co-propylene oxide), or fatty alcohol poly(ethylene oxide-co-propylene oxide) and mixtures thereof. The number of alkoxylene groups in the non-ionic surfactant is at least 8, preferably 8-85, more preferably 10-85 and most preferably 10-80 repeating units. The alkyl groups may each independently of one another be branched or straight-chained, saturated or unsaturated.

Preferred non-ionic surfactants (C) are as follows:

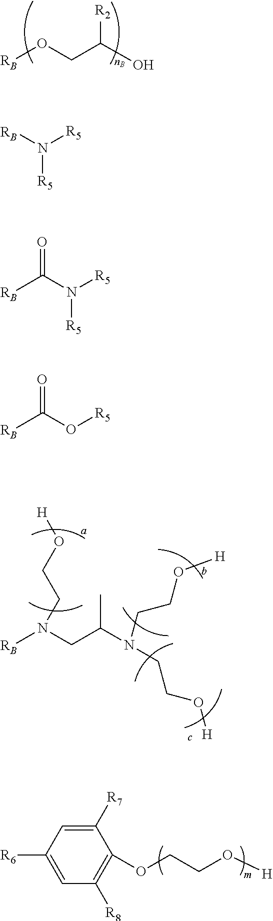

where
R_{B} is a saturated or unsaturated hydrocarbon radical having 8-22 carbon atoms,
R₅ independently of one another are

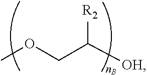

R₆, R₇ and R₈ independently of one another are H or a saturated or unsaturated hydrocarbon radical having 8-18 carbon atoms,
n₈ is 8-80,
a+b+c is 10-115, and
m is 10-200.

The composition preferably contains 8-60% by weight, more preferably 10-55% by weight, of component (C), based on the total mass of components (A), (B) and (C).

The composition according to the invention may contain at least one liquid medium (D). Preferably, the liquid medium is a solvent, in particular water, or a polar organic solvent or a mixture thereof. Preferred polar organic solvents are alcohol, glycol, glycol ether, ether, ketone or mixtures thereof. The organic solvents of ethanol, isopropyl alcohol, glycerine, monoethylene glycol, diethylene glycol, 1,2-propylene glycol, dipropylene glycol, butyl diglycol, dipropylene glycol monomethyl ether, mono-, di-ethylene glycol monobutyl ether, N-methyl pyrrolidone, acetone or mixtures thereof are particularly preferred.

The composition according to the invention preferably contains 40-99.9% by weight, more preferably 50-99.7% by weight, of component (D), based on the total composition.

Component (D) may be introduced into the composition separately or together with the components consisting of (A), (B) and (C). The composition may be present as a concentrate (for example 50-70% by weight of component (D) based on the total composition) or in a diluted form. Diluted compositions are also used as a liquor. A “liquor” is understood to be a composition ready for use for treating a textile or a fibre. The liquor preferably contains 0.001-1%, by weight, more preferably at most 0.5% by weight, most preferably 0.1-0.5% by weight, of components (A), (B) and (C), based on the total mass of the liquor.

The composition may further contain at least one textile additive, for example an antistatic agent, hydrophilisation agent, flame retardant, softener, dewrinkling agent, lubricant, UV resistance agent, anticorrosive agent or fluorine-free or fluorine-containing hydrophobisation agent.

To adjust the pH of the composition, pH regulators may optionally be used. Suitable pH regulators are known to a person skilled in the art.

A further aspect of the present invention relates to a method for producing the above-described composition, comprising the steps of:
a) providing component (A), optionally in a liquid medium,
b) providing component (B), optionally in a liquid medium,
c) providing component (C), optionally in a liquid medium,
d) optionally providing component (D), and
e) mixing the products obtained in steps a)-d).

For mixing (step e)) the products obtained in steps a) to d), methods known to a person skilled in the art may be used. Preferably, step e) takes place using homogenisers known in the field, for example in a temperature range of 20-100° C.

In a further aspect of the invention, the composition according to the invention is used for antistatic and/or hydrophilising finishing of fibres, textiles or (synthetic) leather, in particular of linear or planar textiles.

Within the meaning of the present invention, “fibres” are natural fibres and synthetic fibres. “Natural fibres” are preferably cotton, wool or silk. “Synthetic fibres” or “artificial fibres” are produced synthetically from natural or synthetic polymers and preferably consist of polyester, polyolefin, preferably polyethylene or polypropylene, more preferably polypropylene, polyamide, polyaramid, such as Kevlar® and Nomex®, polyacrylonitrile, elastane or viscose.

Within the meaning of the invention, a “textile” is produced from a plurality of fibres. Preferably, the textile is linear or planar. A “linear textile” is understood to be a yarn, a twine or a rope. “Planar textiles” are preferably non-wovens, felts, woven fabrics, knitted fabrics and meshes. According to the invention, textiles may also contain mixtures of natural fibres and synthetic fibres.

Within the meaning of the present invention, “antistatic” finishing means increasing the electrical conductivity at the surface of the material to be finished so as to counter electrostatic charging. Preferably, the electrical resistance at the surface of the finished material is 10⁹ to 9×10¹¹ ohms (measured as per DIN EN 1149-1).

Within the meaning of the present invention, hydrophilicity is the measure of the capacity of a material to absorb water. A material is referred to as “hydrophilic” within the meaning of the present invention if the absorbency of the material is 1-30 seconds as per the TEGEWA drip test.

A further aspect of the invention is a method for finishing fibres, textiles or (synthetic) leather, comprising the steps of:
(i) providing fibres, textiles or (synthetic) leather,
(ii) applying the composition according to the invention to the fibres, textiles or (synthetic) leather,
(iii) optionally removing the liquid medium (D) at least in part at temperatures above room temperature (RT=20° C.) and optionally at reduced pressure (for example at 0-1,000 mbar, preferably 50-800 mbar),

The composition according to the invention is preferably applied in liquid form to the textiles. The application preferably takes place at room temperature. The composition according to the invention may be applied to the substrate, for example the textile, fibre or (synthetic) leather, in various ways—known to a person skilled in the art—for the finishing. Suitable methods are for example spraying, dipping, soaking, spreading or sponge application. Further, the composition according to the invention may be applied by non-exhaust application or by exhaust methods. Usually, in non-exhaust application, a liquor is provided at the desired concentration and applied on the foulard with liquor uptakes of 40-100% by non-exhaust application. Within the meaning of the present invention, “liquor uptake” is understood to mean the absorbed amount of liquid in percent based on the weight of the dry product.

The method is usually set up in such a way that the finished material makes up approximately 0.1-7% by weight, preferably 0.3-5% by weight, of components (A), (B) and (C) based on the total mass of the fibres, textile or (synthetic) leather.

The method according to the invention may further comprise a post-treatment step (iv) in which the textile is fully dried and/or fixed. Step (iv) may be carried out at 80-160° C., preferably at 100-130° C.

Accordingly, a further subject matter of the invention is a fibre, textile or (synthetic) leather which is obtainable by the above-described method or which comprises the composition according to the invention. In the fibre, textile or (synthetic) leather according to the invention, the components (A), (B) and (C) of the composition make up approximately 0.1-7% by weight, preferably 0.3-5% by weight, based on the total mass of the finished fibre, textile or (synthetic) leather.

The composition according to the invention may also be used as an additive in a textile additive formulation, for example a washing agent formulation. For this purpose, the composition according to the invention is present in a liquid or solid form, preferably in a liquid form. The proportion of components (A), (B) and (C) makes up preferably 1-10% by weight, more preferably 2-8% by weight, based on the washing agent formulation.

Surprisingly, it has been found that the compositions according to the invention are suitable for finishing fibres, textiles or (synthetic) leather antistatically and hydrophilically. Further, it has been found that the finish is wash-resistant. Within the meaning of the present invention, “wash-resistance” means that the desired properties given by the finishing agent, for example antistatic properties and/or hydrophilicity, are not or are barely reduced even after repeated washing in household washing machines. Preferably, the desired properties are not worsened or worsened by not more than 20% after 10-20 or 5-10 washes in household washing machines.

Surprisingly, the wash-resistant finish was achievable not only for natural fibres, but also in particular in synthetic fibres such as PE, PA, PAN and PP, which usually are difficult to finish and can scarcely be finished wash-resistantly as a result of a lack of functional groups. The compositions according to the invention can be applied in a single-step process at room temperature or at ambient temperature. Further, the composition according to the invention is stable in a wide range of concentrations. Within the meaning of the invention, “stable” means that no sediment is formed. In the case of the concentrate, preferably after 3 months, more preferably after 6 months, even more preferably after 12 months, at 4° C., at 25-30° C. or at 40° C., no sediment formation is observed. In the case of a liquor preparation, the composition preferably remains stable for up to 1.5-2 hours, more preferably for up to 4 hours, even more preferably for up to 8 hours, at 4° C., at 25-30° C. or at 40° C.; in other words, no sediment forms during this period. This property of the composition makes it possible for the fibres and textiles to be finished homogeneously and means that no sediments or depositions form on the materials to be finished.

In the following, the invention is described by way of examples. These examples are not to be considered limiting.

### Materials

Poly-DADMAC: polydiallyl dimethyl ammonium chloride, active substance 53% Copolymer DADMAC/diallyl amine: active substance 38% Hostapur SAS 60: C13-C17 secondary alkane sulphonate, sodium salt, active substance 60%

Hostaphat 1306: C13 hydrocarbon radical, 6 EO, phosphate ester, active substance 100% Ether sulphate: C12-C14 hydrocarbon radical, 4 EO, sulphate, sodium salt, active substance 70%

Hordaphos 222: C12-C14 hydrocarbon radical, 4 EO, phosphate, active substance 100%

Lutensol TO 20: C13 hydrocarbon radical, 20 EO, alkyl polyethylene glycol ether-based, active substance 100%

Lutensol TO 129: C13 hydrocarbon radical, 12 EO, alkyl polyethylene glycol ether-based, active substance 90%

Lutensol AT 80: C16-C18 hydrocarbon radical, 80 EO, alkyl polyethylene glycol ether-based, active substance 100%

Marlipal 16/18-25: C16-C18 hydrocarbon radical, 25 EO, alkyl polyethylene glycol ether-based, active substance 100%

Leunapon F 11/40E: C9-C11 hydrocarbon radical, 40 EO, active substance 100%

Dowanol DPM: dipropylene glycol monomethyl ether

### EXAMPLE 1

Into a beaker with stirrer (magnetic stir bar), 48 g water were placed. While stirring, 15 g of the fatty alcohol “Lutensol TO-20” (C13, 20EO) were added. The mixture was heated to 80° C. and the surfactant was thus fully dissolved. Subsequently, 17 g of a secondary alkane sulphonate (Hostapur SAS 60) were added and dissolved therein. In succession, 10 g Dowanol (dipropylene glycol monomethyl ether) and 10 g aqueous poly-DADMAC (active substance 53%) were added. The initially cloudy mixture was cooled while stirring. A clear colloidal solution formed.

A liquor was produced by diluting 40 g of the obtained product to 1000 ml with water. The textiles to be finished were finished with the product by dipping in the liquor and subsequent squeezing out (padding). The pressure on the foulard was selected in such a way that the moisture uptake was 100%.

After 3, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 1.10E+11 | 4.60E+10 | 4.20E+11 | 5 | 8 | 9 |
| 1 | | | | | | |

Polyamide 6.6, meshwork: antistatic zero value 1.0×10¹⁴ ohms, hydrophilicity >80 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 9.50E+10 | 5.00E+10 | 2.90E+11 | 6 | 9 | 10 |
| 1 | | | | | | |

Polyacrylonitrile (woven): antistatic zero value 1.0×10¹⁴ ohms, hydrophilicity >10 s.

| | Finish | | | | | |
|---|---|---|---|---|---|---|
| | Antistatic | Antistatic | Antistatic | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 3.40E+10 | 6.00E+10 | 1.40E+10 | 3 | 3 | 5 |
| 1 | | | | | | |

### EXAMPLE 2

Into a beaker with stirrer (magnetic stir bar), 47.2 g water were placed. While stirring, 15 g “Marlipal 68/18-25” were added. The mixture was heated to 80° C. and the surfactant was thus fully dissolved. Subsequently, 17.8 g ether sulphate were added and dissolved therein, in succession, 10 g butyl diglycol and 10 g aqueous poly-DADMAC were added. A clear colloidal solution formed. The clear mixture was cooled while stirring.

A liquor was produced by diluting 40 g of the obtained product to 1000 ml with water. The textiles to be finished were finished with the product by dipping in the liquor and subsequent squeezing out (padding). The pressure on the foulard was selected in such a way that the moisture uptake was 100%.

After 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Antistatics | Antistatics | Sink time | Sink time |
|---|---|---|---|---|
| | after 5 | after 10 | after 5 | after 10 |
| | washes | washes | washes | washes |
| Finish | 40° C. [ohms] | 40° C. [ohms] | 40° C. [s] | 40° C. [s] |
| Example 2 | 7.5E+10 | 1.1E+11 | 5 | 9 |

Polyamide 6.6, meshwork: antistatic zero value 1.0×10¹⁴ ohms, hydrophilicity >80 s.

| | Antistatics | Antistatics | Sink time | Sink time |
|---|---|---|---|---|
| | after 5 | after 10 | after 5 | after 10 |
| | washes | washes | washes | washes |
| Finish | 40° C. [ohms] | 40° C. [ohms] | 40° C. [s] | 40° C. [s] |
| Example 2 | 2.6E+11 | 1.0E+14 | 3 | 11 |

### EXAMPLE 3

Into a beaker with stirrer (magnetic stir bar), 50 g water were placed. While stirring, 11 g “Lutensol TO 20” were added. The mixture was heated to 80° C. and the surfactant was thus fully dissolved. Subsequently, 20.0 g “Hordaphos 222” (which may also be used partially neutralised or fully neutralised) were added and dissolved therein. In succession, 10 g butyl diglycol and 9 g aqueous copolymer of dimethyl amine and epichlorohydrin (active substance 50%) were added. A clear colloidal solution formed. The clear mixture was cooled while stirring.

A liquor was produced by diluting 40 g of the obtained product to 1000 ml with water. The textiles to be finished were finished with the product by dipping in the liquor and subsequent squeezing out (padding). The pressure on the foulard was selected in such a way that the moisture uptake was 100%.

After 3, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 2.3E+11 | 6.5E+10 | 6.5E+10 | 2 | 6 | 6 |
| 3 | | | | | | |

Polyamide 6.6, meshwork: antistatic zero value 1.0×10¹⁴ ohms, hydrophilicity >80 s.

| | Finish | | | | | |
|---|---|---|---|---|---|---|
| | Antistatic | Antistatic | Antistatic | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 9.5E+11 | 6.5E+12 | 1E+14 | 6 | 8 | 24 |
| 3 | | | | | | |

Wool (woven): antistatic, zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 7.5E+8 | 2.3E+9 | 1.5E+10 | 5 | 6 | 16 |
| 3 | | | | | | |

Polypropylene: antistatic zero value 1.0-10¹⁴ ohm, hydrophilicity >180 s.

| | Finish | | | | | |
|---|---|---|---|---|---|---|
| | Antistatic | Antistatic | Antistatic | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 2.5E+10 | 9.0E+10 | 8.5E+10 | 3 | 4 | 8 |
| 3 | | | | | | |

### EXAMPLE 4

Into a beaker with stirrer (magnetic stir bar), 57.9 g water were placed. While stirring, 5 g “Lutensol AT 80” were added. The mixture was heated to 80° C. and the surfactant was thus fully dissolved. Subsequently, 20.0 g “Flordaphos 222” (which may also be used partially neutralised or fully neutralised) were added and dissolved therein. In succession, 10 g butyl diglycol and 7.1 g aqueous poly(dichloroethyl ether tetramethyl ethylene diamine) (active substance 60%) were added. A clear colloidal solution formed. The clear mixture was cooled while stirring.

A liquor was produced by diluting 40 g of the obtained product to 1000 ml with ater. The textiles to be finished were finished with the product by dipping in the liquor and subsequent squeezing out (padding). The pressure on the foulard was selected in such a way that the moisture uptake was 100%.

After 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Antistatics | Antistatics | Sink time | Sink time |
|---|---|---|---|---|
| | after 5 | after 10 | after 5 | after 10 |
| | washes | washes | washes | washes |
| Finish | 40° C. [ohms] | 40° C. [ohms] | 40° C. [s] | 40° C. [s] |
| Example 4 | 2.0E+10 | 1.0E+14 | 1 | 2 |

Polyamide 6.6, meshwork: antistatic zero value 1.0×10¹⁴ ohms, hydrophilicity >80 s.

| | Antistatics | Antistatics | Sink time | Sink time |
|---|---|---|---|---|
| | after 5 | after 10 | after 5 | after 10 |
| | washes | washes | washes | washes |
| Finish | 40° C. [ohms] | 40° C. [ohms] | 40° C. [s] | 40° C. [s] |
| Example 4 | 1.7E+11 | 1.0E+14 | 1 | 2 |

### EXAMPLE 5

in Into a beaker with stirrer (magnetic stir bar), 49.3 g water were placed. While stirring, 16.7 g “Lutensol TO 129” were added. The mixture was heated to 80° C. and the surfactant was thus fully dissolved. Subsequently, 14 g “Hostaphat 1306” (which may also be used partially neutralised or fully neutralised) were added and dissolved therein. In succession, 10 g butyl diglycol and 10 g aqueous poly--DADMAC were added. The initially cloudy mixture was cooled while stirring. A clear colloidal solution formed.

A liquor was produced by diluting 40 g of the obtained product to 1000 ml with water. The textiles to be finished were finished with the product by dipping in the liquor and subsequent squeezing out (padding). The pressure on the foulard was selected in such a way that the moisture uptake was 100%.

After 3, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 1.2E+9 | 5E+9 | 4.4E+9 | 3 | 5 | 7 |
| 5 | | | | | | |

Polyamide 6.6, meshwork: antistatic zero value 1.0×10¹⁴ ohms, hydrophilicity >80 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 5.5E+9 | 2.9E+10 | 2.4E+10 | 10 | 17 | 53 |
| 5 | | | | | | |

Wool (woven): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 4.4E+8 | 2.3E+9 | 1.3E+10 | 6 | 9 | 10 |
| 5 | | | | | | |

Polypropylene: antistatic zero value 1.0×10¹⁴ ohm, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 1.1E+10 | 2.5E+10 | 2.3E+10 | 1 | 5 | 5 |
| 5 | | | | | | |

### EXAMPLE 6

Into a beaker with stirrer (magnetic stir bar), 55.3 g water were placed. While stirring, 20 g “Leunapon F 11/40E” were added. The mixture was heated to 80° C. and the surfactant was thus fully dissolved. Subsequently, 4.7 g homopolyacrylic acid (active substance 50%) were added and dissolved therein. In succession, 10 g butyl diglycol and 10 g aqueous poly-1.0 DADMAC were added. The cloudy mixture was cooled while stirring. An opaque colloidal solution formed.

A liquor was produced by diluting 40 g of the obtained product to 1000 ml with water. The textiles to be finished were finished with the product by dipping in the liquor and subsequent 1.5 squeezing out (padding). The pressure on the foulard was selected in such a way that the moisture uptake was 100%.

After 3, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 8.0E+10 | 4.0E+10 | 3.6E+10 | 4 | 4 | 5 |
| 6 | | | | | | |

Polyamide 6.6, meshwork: antistatic zero value 1.0×10¹⁴ ohms, hydrophilicity >80 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 1.6E+11 | 3.8E+11 | 8.5E+11 | 12 | 14 | 58 |
| 8 | | | | | | |

Wool (woven): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 3.0E+10 | 8.5E+10 | 1.1E+11 | 15 | 33 | 34 |
| 6 | | | | | | |

Polypropylene: antistatic zero value 1.0<10¹⁴ ohm, hydrophilicity >180 s,

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 2.5E+11 | 1.5E+11 | 2.3E+11 | 4 | 5 | 17 |
| 6 | | | | | | |

### EXAMPLE 7

Into a beaker with stirrer (magnetic stir bar), 41.2 g water were placed. While stirring, 15 g “Marlipal 16/18-25” were added. The mixture was heated to 80° C. and the surfactant was thus fully dissolved. Subsequently, 17.8 g ether sulphate and 1 g homopolyacrylic acid (active substance 50%) were added and dissolved therein. In succession, 15 g butyl diglycol and 10 g aqueous poly-DADMAC were added. The cloudy mixture was cooled while stirring. An opaque colloidal solution formed,

A liquor was produced by diluting 40 g of the obtained product to 1000 ml with water. The textiles to be finished were finished with the product by dipping in the liquor and subsequent squeezing out (padding). The pressure on the foulard was selected in such a way that the moisture uptake was 100%.

After 0, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | before | after 5 | after 10 | after 3 | after 5 | after 10 |
| | washing | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 5.5E+6 | 8.0E+9 | 8.5E+9 | 3 | 7 | 14 |
| 7 | | | | | | |

Polyamide 6.6, meshwork: antistatic zero value 1.0×10¹⁴ ohms, hydrophilicity >80 s.

| | Finish | | | | | |
|---|---|---|---|---|---|---|
| | Antistatics | Antistatics | Antistatics | Sink time | Sink time | Sink time |
| | before | after 5 | after 10 | after 3 | after 5 | after 10 |
| | washing | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Example | 5.5E+7 | 4.6E+10 | 4.8E+10 | 4 | 9 | 20 |
| 7 | | | | | | |

### Comparative Example 1, Two-Step Process

A liquor comprising 10 g/l cationic surfactant, coco-dip-hydroxyethyl)-methyl ammonium chloride (active substance 100%), is “padded” onto the textile. The textile is subsequently dried. In a second step, a liquor comprising 17.2 g/l anionic surfactant, Hostapur SAS 60, is “padded” on.

During both finishes, the pressure on the foulard was selected in such a way that the moisture uptake is 100%.

After 0, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 0 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 1.8E+9 | 1.0E+14 | 1.0E+14 | 1 | 180 | 180 |
| example | | | | | | |
| 1 | | | | | | |

(no wash-resistance)

Polyamide 6.6, meshwork: antistatic zero value 1.0×10¹⁴ ohms, hydrophilicity >80 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 1.4E+11 | 1.0E+14 | 1.0E+14 | 1 | 4 | 2 |
| example | | | | | | |
| 1 | | | | | | |

(no wash-resistance)

### Comparative Example 2, Two-Step Process

A liquor comprising 10 g/l cationic surfactant, C12-C16 alkyl dimethyl benzyl ammonium 1.5 chloride (active substance 50%), is “padded” onto the textile. The textile is subsequently dried. In a second step, a liquor comprising 17.2 g/l anionic surfactant, Hostapur SAS 60, is “padded” on.

During both finishes, the pressure on the foulard was selected in such a way that the moisture uptake is 100%.

After 0, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 0 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 7.5E+9 | 1.0E+14 | 1.0E+14 | 1 | 180 | 180 |
| example | | | | | | |
| 2 | | | | | | |

(no wash-resistance)

Polyamide 6.6, meshwork: antistatic zero value 1.0×10¹⁴ ohms, hydrophilicity >80 s.

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 1.0E+13 | 1.0E+14 | 1.0E+14 | 1 | 2 | 1 |
| example | | | | | | |
| 2 | | | | | | |

(no wash-resistance)

### Comparative Example 3, Two-Step Process

A liquor comprising 10 g/l cationic surfactant, coca-di(2-hydroxyethyl)-methyl ammonium chloride (active substance 100%), is “padded” onto the textile. The textile is subsequently dried. In a second step, a liquor comprising 19.2 g/l anionic surfactant, ether sulphate, is “padded” on.

During both finishes, the pressure on the foulard was selected in such a way that the moisture uptake is 100%.

After 0, 5 and 10 household washes, the antistatic value and hydrophilicity were measured as per DIN EN 1149-1 and TEGEWA drip test.

Polyester (polyethylene terephthalate, meshwork): antistatic zero value 1.0 k 10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 0 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 1.0E+9 | 1.0E+14 | 1.0E+14 | 1 | 180 | 180 |
| example | | | | | | |
| 3 | | | | | | |

(no wash-resistance)

Polyamide 6.6, meshwork: antistatic zero value 1.0×10¹⁴ ohms, hydrophilicity >80 s,

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 1.2E+10 | 1.0E+14 | 1.0E+14 | 1 | 3 | 1 |
| example | | | | | | |
| 3 | | | | | | |

(no wash-resistance)

### Comparative Example 4, Two-Step Process

A liquor comprising 10 g/l cationic surfactant, alkyl dimethyl benzyl ammonium chloride (active substance 50%), is “padded” onto the textile. The textile is subsequently dried. In a second step, a liquor comprising 21.5 anionic surfactant, Hordaphos 222, is “padded” on.

During both finishes, the pressure on the foulard was selected in such a way that the moisture uptake is 100%.

After 0, 5 and 10 household washes, the antistatic value and hydrophilicity were measured as per DIN EN 1149-1 and TEGEWA drip test.

Polyester (polyethylene terephthalate, meshwork): antistatic zero value 1.0×10¹⁴ ohms, hydrophilicity >180 s.

| | Finish | | | | | |
|---|---|---|---|---|---|---|
| | Antistatics | Antistatics | Antistatics | Sink time | Sink time | Sink time |
| | after 0 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 3.2E+8 | 1.0E+14 | 1.0E+14 | 1 | 92 | 173 |
| example | | | | | | |
| 4 | | | | | | |

(no wash-resistance)

Polyamide 6.6, meshwork: antistatic zero value 1.0×10¹⁴ ohms, hydrophilicity >80 s,

| | Finish | | | | | |
|---|---|---|---|---|---|---|
| | Antistatics | Antistatics | Antistatics | Sink time | Sink time | Sink time |
| | after 3 | after 5 | after 10 | after 3 | after 5 | after 10 |
| | washes | washes | washes | washes | washes | washes |
| | 40° C. | 40° C. | 40° C. | 40° C. | 40° C. | 40° C. |
| | [ohms] | [ohms] | [ohms] | [s] | [s] | [s] |
| Comp. | 3.8E+9 | 1.0E+14 | 1.0E+14 | 1 | 2 | 1 |
| example | | | | | | |
| 4 | | | | | | |

(no wash-resistance)

### Comparative Example 5: Production without Non-Ionic Surfactant

Into a beaker with stirrer (magnetic stir bar), 48 g water were placed. While stirring, 17 g Hostapur SAS 60 were added and dissolved therein. In succession, 10 g Dowanol DPM and 10 g aqueous poly-DADMAC were added. The mixture formed insoluble precipitates and could not be used.

The following points are subject matter of the invention:

1. Composition comprising:
(A) at least one cationic polyelectrolyte,
(B) at least one anionic compound,
(C) at least one non-ionic surfactant, and
(D) optionally at least one liquid medium.

2. Composition according to point 1 in the form of a colloid.

3. Composition according to either point 1 or point 2, wherein the colloid particles have an average diameter of 5 nm to 3 μm.

4. Composition according to any of points 1-3, wherein the composition is optically transparent or opaque.

5. Composition according to any of the preceding points, wherein the polyelectrolyte (A) is a polymer having side-chain and/or main-chain cationic groups.

6. Composition according to any of the preceding points, wherein the polyelectrolyte (A) is obtainable by (i) polymerising at least three monomer units which each have a permanent cationic charge and/or (ii) by condensation reactions which lead to at least three cationic groups and/or (iii) by alkylation of at least three amino functions in a polymer into permanent cationic groups.

7. Composition according to any of the preceding points, wherein the polyelectrolyte (A) is a homopolymer or copolymer.

8. Composition according to point 7, wherein the polyelectrolyte copolymer comprising at least one repeating unit based on a comonomer selected from the group consisting of styrene, acrylonitrile, (meth)acrylic acid ester, (meth)acrylamide, (meth)acrylic acid, vinyl acetate and allyl alcohol derivative,

9. Composition according to any of points 6-8, wherein the monomer unit (i) comprises an ammonium, pyridinium, imidazolium, pyrrolidonium group or an N-substituted heteroaromatic group.

10. Composition according to any of points 6-9, wherein the monomer unit (i) is selected from the group consisting of diallyl dialkyl ammonium salt, in particular diallyl dimethyl ammonium chloride (DADMAC), trialkyl ammonium alkyl (meth)acrylate salt and trialkyl ammonium alkyl (meth)acrylamide salt.

11. Composition according to any of points 6-8, wherein the condensation reaction (ii) comprises conversion of at least one dialkyl amine, tertiary alkyl and/or (hetero)aryl diamine with at least one epihalohydrin and/or bishalide.

12. Composition according to any of points 6-8, wherein the polymer comprising at least three amino functions in (iii) is selected from the group consisting of linear or branched polyalkylene imine, in particular polyethylene imine, or is obtainable by polymerising at least three monomer units selected from the group consisting of diallyl dialkyl amine, vinyl amine, vinyl pyrazole, vinyl imidazole and/or aziridine.

13. Composition according to any of the preceding points, wherein component (A) makes up 4-62% by weight, preferably 5-55% by weight, based on the total mass of components (A), (B) and (C).

14. Composition according to any of the preceding points, wherein component (A) has a number-average molecular weight of 1,000-5,000,000 g/mol, preferably 1,000-1,000000 g/mol.

15. Composition according to any of the preceding points, wherein 30-100 mol %, preferably 50-100 mol %, of the repeating units in component (A) have a cationic group.

16. Composition according to any of the preceding claims, wherein the anionic compound (8) has at least one, preferably 1-3, anionic groups or is an anionic polyelectrolyte.

17. Composition according to any of the preceding points, wherein the anionic compound (B) comprises at least one phosphate, phosphonate, sulphate, sulphonate, carboxylate, sulphoacetate, sulphosuccinate and/or taurate group.

18. Composition according to any of the preceding points, wherein the anionic compound (B) is selected from mono-, di-(C₄₋₂₂ alkyl(alkoxy)) phosphate, mono-, di-(C₄₋₂₂ alkyl) phosphonate, C₄₋₂₂ alkyl aminophosphonate, C₄₋₂₂ alkyl(alkoxy) sulphate, secondary alkyl sulphonate, petroleum sulphonate, C₄₋₂₂ alkyl sulfonate, C₄₋₂₂ alkyl aryl sulphonate, fatty alcohol ether carboxylate, fatty acid salt, fatty alkyl sulphoacetate, fatty acid amide ether sulphate, fatty alcohol ether carboxylate, nonyl phenol ether sulphate, fatty alkyl ether sulphate, C₄₋₂₂ alkyl polyalkoxylene phosphate and C₄₋₂₂ alkyl polyalkoxylene sulphate.

19. Composition according to point 16, wherein the polyelectrolyte (B) is a polymer having side-chain anionic groups.

20. Composition according to point 19, wherein the polyelectrolyte is obtained by polymerising at least three monomer units (iv), which each have at least one chemically ionisable group.

21. Composition according to point 20, wherein the monomer unit (iv) is selected from the group consisting of (meth)acrylic acid, maleic acid, 2-acrylamido-2-methyl propane sulphonic acid, allyl sulphonic acid and styrene sulphonic acid.

22. Composition according to any of points 16, 17, 19, 20 and 21, wherein the polyelectrolyte (B) is a homopolymer or copolymer.

23. Composition according to point 22, wherein the polyelectrolyte copolymer comprises at least one repeating unit based on a comonomer selected from the group consisting of styrene, acrylonitrile, (meth)acrylic acid ester and/or (meth)acrylic amide.

24. Composition according to any of the preceding points, wherein component (B) makes up 15-85 by weight, preferably 20-80% by weight, based on the total mass of components (A), (B) and (C).

25. Composition according to any of the preceding points, wherein component (A) and component (B) together form an ionic complex.

26. Composition according to any of the preceding points, wherein the ratio of the net charge in component (A) to the net charge in component (B) is 1:10 to 10:1, preferably 1:7 to 7:1.

27. Composition according to any of the preceding points, wherein component (C) is an alkoxylation product of fatty acid, fatty acid ester, fatty acid amine, fatty acid amide, fatty alcohol, aliphatic mono-, di- or tri-alcohol, mono-, di- or tri-glyceride, alkyl phenol, sorbitan fatty acid and sugar derivatives or is trialkyl phenol polyalkoxylene or a block copolymer, for example poly(ethylene oxide-co-propylene oxide).

28. Composition according to any of the preceding points, wherein component (C) makes up 8-60% by weight, preferably 10-55% by weight, based on the total mass of components (A), (B) and (C).

29. Composition according to any of the preceding points, wherein the liquid medium (D) is selected from water, an organic solvent, preferably alcohol, glycol (ether), ether, ketone or mixtures thereof.

30. Composition according to any of the preceding points, wherein component (D) makes up 40-99.9% by weight, preferably 50-99.7% by weight, based on the total composition.

31. Composition according to any of the preceding points, further comprising at least one textile additive, for example an antistatic agent, hydrophilisation agent, flame retardant, softener, dewrinkling agent, lubricant, UV resistance agent, anticorrosive agent or fluorine-free or fluorine-containing hydrophobisation agent.

32. Composition according to any of the preceding claims, comprising:
(A) at least one cationic polyelectrolyte,
(B) at least one anionic compound,
(C) at least one non-ionic surfactant, and
(D) optionally at least one liquid medium,
   wherein the composition is in the form of a colloid and the ratio of the net charge in component (A) to the net charge in component (B) is 1:10-10:1.

33. Method for producing a composition according to any of points 1-32, comprising the steps of:
a) providing component (A), optionally in a liquid medium,
b) providing component (B), optionally in a liquid medium,
c) providing component (C), optionally in a liquid medium,
d) optionally providing component (D), and
e) mixing the products obtained in steps a)-d).

34. Use of the composition according to any of points 1-32 for antistatic and/or hydrophilic finishing of fibres, textiles or (synthetic) leather, in particular of linear or planar textiles.

35. Use according to point 34, wherein the fibre or the textile is made of synthetic fibres, in particular polyester, polyolefin, preferably polyethylene or polypropylene, more preferably polypropylene, polyimide, polyaramid, polyacrylonitrile, elastane or viscose, natural fibres, in particular wool, cotton or silk, or mixtures thereof.

36. Use of the composition according to any of points 1-32 as an additive in textile additive formulations, for example washing agent formulations.

37. Method for finishing fibres, textiles or (synthetic) leather, comprising the steps of:
i) providing fibres, textiles or (synthetic) leather,
ii) applying a composition according to any of points 1-32 to the fibres, textiles or (synthetic) leather,
iii) optionally removing the liquid medium (D) at least in part at temperatures above room temperature and optionally at reduced pressure.

38. Fibre, textile or (synthetic) leather obtainable by a method according to point 37.

39. Fibre, textile or (synthetic) leather comprising a composition according to any of points 1-32.

40. Fibre, textile or (synthetic) leather according to either point 38 or point 39, wherein the components (A), (B) and (C) in the composition make up 0.1-7% by weight, based on the total mass of the finished fibre, textile or (synthetic) leather.

1. A composition comprising:
(A) at least one cationic polyelectrolyte,
(B) at least one anionic compound,
(C) at least one non-ionic surfactant, and
(D) optionally at least one liquid medium.

2. The composition according to claim 1 in the form of a colloid, wherein the colloid particles preferably have an average diameter of 5 nm to 3 μm.

3. The composition according to claim 1, wherein the polyelectrolyte (A) is obtainable by (i) polymerising at least three monomer units which each have a permanent cationic charge and/or (ii) by condensation reactions which lead to at least three cationic groups and/or (iii) by alkylation of at least three amino functions in a polymer into permanent cationic groups.

4. The composition according to claim 1, wherein the anionic compound (B) has at least one, preferably 1-3, anionic groups or is an anionic polyelectrolyte.

5. The composition according to claim 1, wherein tire anionic compound (B) comprises at least one phosphate, phosphonate, sulphate, sulphonate, carboxylate, sulphoacetate, sulphosuccinate and/or taurate group.

6. The composition according to claim 1, wherein the ratio of the net charge in component (A) to the net charge in component (B) is 1:10 to 10:1, preferably 1:7 to 7:1.

7. The composition according to claim 1, comprising:
(A) at least one cationic polyelectrolyte,
(B) at least one anionic compound,
(C) at least one non-ionic surfactant, and
(D) optionally at least one liquid medium,
wherein the composition is in the form of a colloid and the ratio of the net charge in component (A) to the net charge in component (B) is 1:10-10:1.

8. The composition according to claim 1, wherein component (C) is an alkoxylation product of fatty acid, fatty acid ester, fatty acid amine, fatty acid amide, fatty alcohol, aliphatic mono-, di- or tri-alcohol, mono-, di- or tri-glyceride, alkyl phenol, sorbitan fatty acid and sugar derivatives or is trialkyl phenol polyalkoxylene or a block copolymer, for example poly(ethylene oxide-co-propylene oxide).

9. The composition according to claim 1, wherein the liquid medium (D) is selected from water, an organic solvent, preferably alcohol, glycol (ether), ether, ketone or mixtures thereof.

10. A method for producing a composition according to claim 1, comprising the steps of:
(a) providing component (A), optionally in a liquid medium,
(b) providing component (B), optionally in a liquid medium,
(c) providing component (C), optionally in a liquid medium,
(d) optionally providing component (D), and
(e) mixing the products obtained in steps a)-d).

11. Use of the composition according to claim 1 for antistatic and/or hydrophilic finishing of fibers, textiles or (synthetic) leather, in particular of linear or planar textiles.

12. Use of the composition according to claim 1 as an additive in textile additive formulations, for example washing agent formulations.

13. A method for finishing fibres, textiles or (synthetic) leather, comprising the steps of:
i) providing fibers, textiles or (synthetic) leather,
ii) applying a composition according to claim 1 to the fibers, textiles or (synthetic) leather,
iii) optionally removing the liquid medium (D) at least in part at temperatures above room temperature and optionally at reduced pressure.

14. A fiber, textile or (synthetic) leather obtainable by a method according to claim 13.

15. The fiber Fibre, textile or (synthetic) leather comprising a composition according to claim 1.

16. The fiber, textile or (synthetic) leather according to claim 14, wherein the components (A), (B) and (C) in the composition make up 0.1-7% by weight, based on the total mass of the finished fiber fibre, textile or (synthetic) leather.
